(19) United States
(12) Patent Application Publication
(10) Pub. No.: US 2003/0156735 A1
(43) Pub. Date: Aug. 21, 2003

(54) Method and arrangement for detecting multiple watermarks in an information signal

(76) Inventors: Maurice Jerome Justin Jean-Baptiste Maes, Eindhoven (NL); Antonius Adrianus Cornelis Maria Kalker, Eindhoven (NL)

Correspondence Address: Daniel J Piotrowski, US Philips Corporation, Intellectual Property Department, 580 White Plains Road, Tarrytown, NY, 10591, US

(21) Appl. No.: 10/240,344

(22) PCT Filed: Feb. 11, 2002
(86) PCT No.: PCT/IB02/00412

(30) Foreign Application Priority Data
Feb. 13, 2001 (EP) 01200524.5

(51) Int. Cl. G06K 9/00; G06K 9/36

(52) U.S. Cl. 382/100; 382/232

(57) ABSTRACT

Given multimedia content with two (possibly different types of) watermarks, the naive way of retrieving both messages is to apply the two detectors independently. In case that geometry retrieval (e.g. undoing scaling) is an integral part of watermark detection, this implies that geometry retrieval is duplicated in both detections. In particular, the combined detection may be unnecessarily complex. The invention provides a solution for this problem. A first watermark detector makes the geometry retrieval parameters available to the second watermark detector, thereby reducing the complexity of the combined detection.

### FIELD OF THE INVENTION

The invention relates to a method and arrangement for detecting multiple watermarks in an information signal, comprising a first watermark detector for detecting a first watermark and a second watermark detector for detecting a second watermark.

### BACKGROUND OF THE INVENTION

Various methods of embedding a watermark in an information (e.g. video, audio) signal, and corresponding methods of detecting said watermark, are known in the art.

International patent application WO 99/45705 discloses a first prior art method. In this method, a watermark is embedded in a video signal by repeating a small-sized basic watermark pattern over the extent of the video image. This “tiling” operation allows the watermark detection process to search the watermark over a relatively small space and improves the reliability of detection. A data payload is encoded into the basic watermark tile.

International patent application WO99/12331 discloses a second known embedding and detecting method. In this prior art method, different sub-patterns of a watermark are embedded in selected ones of a plurality of image blocks into which the image is divided.

It is currently envisaged to merge two such different watermark embedding methods (although not necessarily the two methods mentioned above). A straightforward way to retrieve both watermarks is to apply a respective first and second watermark detector. This implies that some tasks, which both detectors have in common, are duplicated. The combined detection may thus be unnecessarily complex and expensive.

### OBJECT AND SUMMARY OF THE INVENTION

It is an object of the invention to alleviate the above mentioned drawback.

To this end, the method of detecting multiple watermarks in the information signal is characterized in that it comprises a step of retrieving from the information signal a parameter which is required for detecting the watermarks, and applying said parameter to the first and second detector. The complexity of the combined detection is thereby considerably reduced.

A typical and important parameter is the geometry of video images. Most watermarking techniques are not resistant against geometrical distortions of the image. Manipulations such as translation, scaling, rotation, or stretching destroy the correlation between the manipulated image and the applied watermark. For example, the above mentioned prior art watermark detectors are resistant against translation but lack the ability of detecting the watermark if the image has been scaled, rotated or stretched. In view thereof, it has been proposed to preprocess the suspect video image so as to undo the manipulation (scaling, rotation, stretching) which the suspect image has undergone after it has been watermarked. In Applicant's non-pre-published European patent application EP00/09087(PHN 17.655) it is proposed to determine the periodicity of the watermark pattern and process the suspect image such that the periodicity of the watermark in the processed suspect image matches the periodicity in the original image. U.S. Pat. No. 5,636,292 discloses adding a separate calibration signal (e.g. a sine wave with a specified frequency) to the image for such purpose. Letting the first watermark detector make the geometry retrieval parameters available to the second watermark detector reduces the complexity of the combined detection. Note that this assumes that both watermarks are embedded at the same original geometry, or at a known difference in geometry.

In a further embodiment of the arrangement and method, the first watermark detector makes synchronization information available to the second detector in case of spread-spectrum watermark detection.

### BRIEF DESCRIPTION OF THE DRAWINGS

FIGS. 1A and 1B show schematically an image with an embedded first and second watermark, respectively.

FIG. 2 shows schematically an embodiment of an arrangement for detecting multiple watermarks in accordance with the invention.

FIGS. 3A-3C show diagrams to illustrate the effects of scaling, rotation and shearing, respectively, on a watermarked image.

FIGS. 4A-4C show correlation patterns provided by a filter of the watermark detector which is shown in FIG. 2.

### DESCRIPTION OF EMBODIMENTS

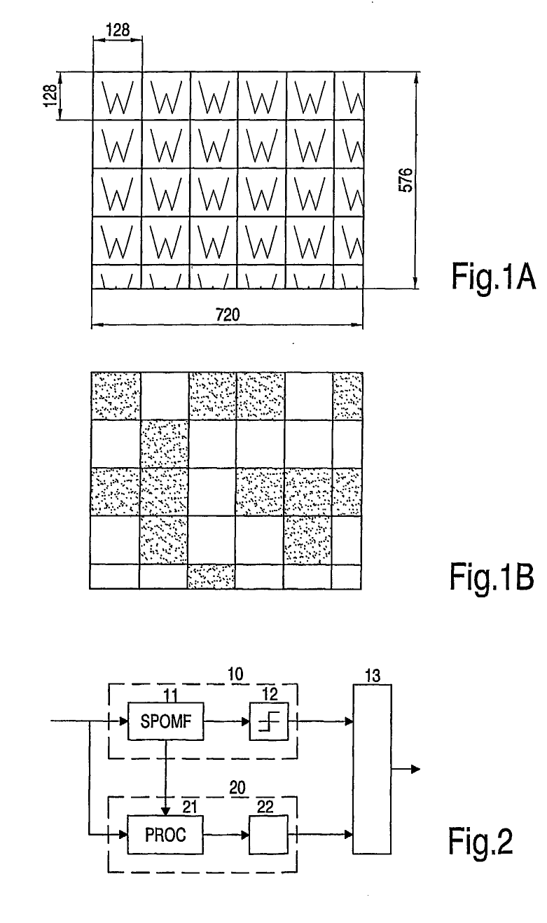

FIGS. 1A and 1B show schematically an image with an embedded first and second watermark, respectively. The first watermark is obtained by “tiling” a basic noise pattern W over the image. Payload is encoded in the basic pattern. The second watermark is a plurality of (not necessarily same) sub-patterns. Payload may be encoded in the presence or absence of such sub-patterns in particular blocks of the image.

FIG. 2 shows schematically an embodiment of the arrangement in accordance with the invention. The arrangement comprises a first watermark detector 10, which is here assumed to be of the type disclosed in WO 99/45705. Detector 10 detects the watermark W (FIG. 1A) by “folding” image blocks of 128×128 pixels in a buffer, and correlating the watermark tile W with the contents of said buffer. The detector is invariant to translation of the image. The multiple watermarked signal is represented by yᵢ=xᵢ+wᵢ+vᵢ, where xᵢ represents the original signal and wᵢ and vᵢ represent two different watermarks. The index i represents a position of the watermark with respect to the image. The arrangement receives a shifted version zᵢ=yᵢ₋ₖ of the marked signal yᵢ. As disclosed in WO 99/45705, the detection of wᵢ in zᵢ is conducted by a Symmetrical Phase Only Matched Filter 11. This process provides a decision variable dᵢ=Σᵢzᵢwᵢ₋₁ which is applied to a threshold stage 12 which detects the absence or presence of the watermark W. The filter 12 also inherently searches over all possible shifts 1 the value of shift k. The first watermark detector 10 applies said value k to the second watermark detector. The second detector, which detects the second watermark vᵢ in zᵢ need no longer search for the translation to which the image was subjected. It is already available from the detection of wᵢ. Detector 20 comprises a processing circuit 21 which in this embodiment shifts the image over the vector k prior to conventional detection 22. In this embodiment, the parameter applied to the second detector represents synchronization information.

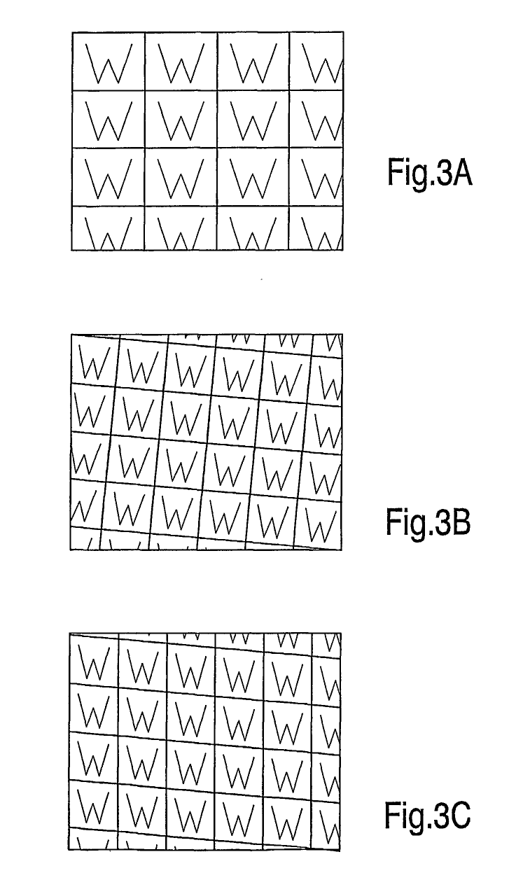

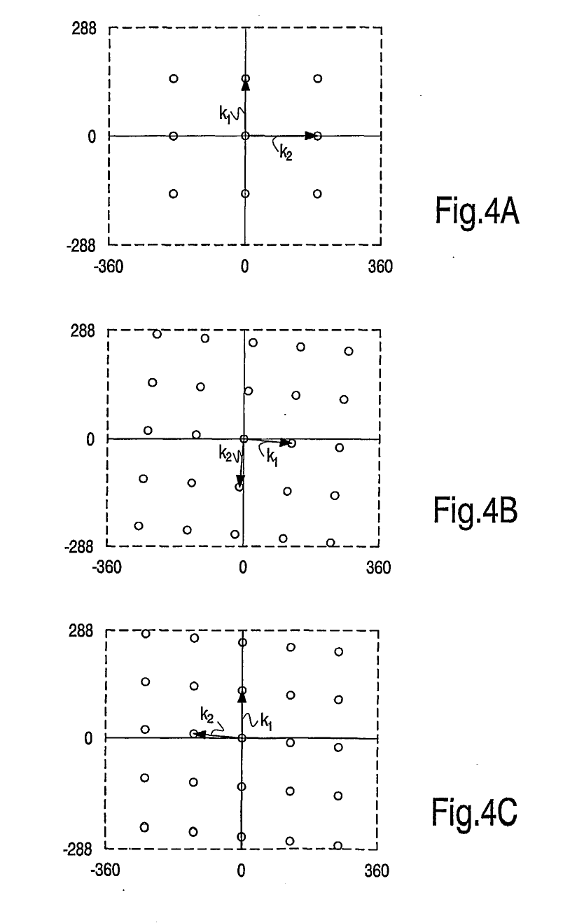

In a second embodiment of the arrangement, the first watermark detector makes available to the second detector the parameters of an affine transformation needed to restore an image to its original geometry at the time of embedding. FIGS. 3A-3C show the effects of scaling, rotation and shearing, respectively, on the image having watermark W. FIGS. 4A-4C show correlation patterns provided by the filter 11 of watermark detector 10 in this embodiment. Two parameters k₁ and k₂ representing the scaling, rotation or shearing are now applied to the processing unit 21 of the second watermark detector 20 to undo the operation to which the image was subjected. Alternatively, the parameters k₁ and k₂ are used to subject the first and/or second reference watermark to the same scaling, rotation or shearing operation so that image and reference watermark are re-aligned.

Summary of the invention. Given multimedia content with two (possibly different types of) watermarks, the naïve way of retrieving both messages is to apply the two detectors independently. In case that geometry retrieval (e.g. undoing scaling) is an integral part of watermark detection, this implies that geometry retrieval is duplicated in both detections. In particular, the combined detection may be unnecessarily complex. The invention provides a solution for this problem. A first watermark detector makes the geometry retrieval parameters available to the second watermark detector, thereby reducing the complexity of the combined detection.

1. An arrangement for detecting multiple watermarks in an information signal, comprising a first watermark detector for detecting a first watermark and a second watermark detector for detecting a second watermark, characterized in that the arrangement comprises parameter retrieving means for retrieving from the information signal a parameter which is required in order to detect the watermarks, and applying said parameter to the first and second detector.

2. The arrangement as claimed in claim 1, wherein said parameter retrieving means are incorporated in the first watermark detector, and the first watermark detector is arranged to apply the retrieved parameter to the second watermark detector.

3. The arrangement as claimed in claim 1 or 2, wherein said parameter identifies the geometry of the information signal.

4. The arrangement as claimed in claim 1 or 2, wherein said parameter represents synchronization information.

5. A method of detecting multiple watermarks in an information signal, comprising the steps of using a first watermark detector for detecting a first watermark and a second watermark detector for detecting a second watermark, characterized in that the method comprises a step of retrieving from the information signal a parameter which is required for detecting the watermarks, and applying said parameter to the first and second detector.
